(19) United States
(12) Patent Application Publication
(10) Pub. No.: US 2008/0286061 A1
(43) Pub. Date: Nov. 20, 2008

(54) Adaptor shank for SDS format pneumatic hammer/ drill gun

(76) Inventor: Richard Lefebvre, Manasquan, NJ (US)

Correspondence Address: CLIFFORD G. FRAYNE, 136 DRUM POINT RD, SUITE 7A, BRICK, NJ, 08723, US

(21) Appl. No.: 12/151,924

(22) Filed: May 12, 2008

Related U.S. Application Data
(60) Provisional application No. 60/930,666, filed on May 18, 2007.

(51) Int. Cl. B23B 51/12

(52) U.S. Cl. 408/226; 408/239 A

(57) ABSTRACT

An adaptor shank for SDS format pneumatic hammer/drill guns, the adaptor shank having a drill bit receiving end with drill bit locking means and an SDS format end for locking engagement with SDS format pneumatic hammer/drill gun, thereby allowing the drill bit alone to be discarded and replaced upon wear or breakage.

### RELATED APPLICATIONS

Applicant claims the benefit of provisional application 60/930,666, filed May 18, 2007.

### BACKGROUND OF THE INVENTION

1. Field of the Invention

The present invention relates to an adaptor for SDS format pneumatic hammer/drill guns for accommodating a replaceable drill bit and snap on driver for rapid drilling of bores in concrete or masonry and the installation of concrete screws therein.

2. Description of the Prior Art

Pneumatic hammer/drill guns commonly come in one of two formats for securing the drill or driver in the pneumatic hammer/drill gun. One format is the conventional chuck format and the other is the SDS format. The present invention relates to the SDS format only.

As will be described in detail hereafter, the SDS format comprises a shank, one end of which has two opposed aligned grooves positioned at 180 degrees to each other on the shank. Disposed in 180 degree relationship with each other between these alignment grooves are two opposed arcuate recessed indents. The alignment grooves serve to align the shank as it is inserted into the pneumatic hammer/drill gun and the two opposed recessed indents are engaged by internal fingers or appendages within the pneumatic hammer/drill gun to retain the shank.

In the prior art, in the SDS format, the shank and drill bit were of one piece construction. Therefore, when the drill bit wore down or broke or snapped, the drill bit and shank as a one piece construction had to be discarded. Due to the fact that the combination shank and drill bit were machined as one piece, this resulted in the loss of an expensive piece of equipment. It would therefore be desirable if the shank and the drill bit were of two piece construction so that the drill bit, being the relatively inexpensive piece of equipment, could be replaced quickly and easily should it become worn or broken.

Applicant's invention relates to an adaptor shank and separate drill bit with locking mechanism which allows only the drill bit to be discarded upon wear or breakage while retaining the adaptor shank for further use with a replaceable drill bit.

### OBJECTS OF THE INVENTION

An object of the present invention is to provide a novel improved SDS format adaptor which allows for the rapid drilling of bores and subsequent installation of concrete and masonry screws.

A still further object of the present invention is to provide a novel improved SDS format adaptor shank and drill bit, of two piece construction with a locking means for the rapid drilling of bores for the installation of concrete or masonry screws.

A still further object of the present invention relates to a novel SDS format adaptor shank and drill bit which allows for only the drill bit to be discarded if broken or worn.

A still further object of the present invention is to provide for an improved SDS format shank and drill bit of two piece construction in which the adaptor shank can adapt to the use of a drive sleeve with driver for the insertion of concrete or masonry screws.

### SUMMARY OF THE INVENTION

An adaptor shank for SDS format pneumatic hammer/drill guns, the adaptor shank having a drill bit receiving end with drill bit locking means and an SDS format end for locking engagement with SDS format pneumatic hammer/drill gun, thereby allowing the drill bit alone to be discarded and replaced upon wear or breakage.

### BRIEF DESCRIPTION OF THE DRAWINGS

These and other objects of the present invention will become apparent, particularly when taken in light of the following illustrations wherein:

FIGS. 1 and 2 are perspective views of an SDS shank and drill bit of the prior art;

FIG. 3 is a cross sectional side view of a sleeve and fastener driver;

FIG. 4 is a top view of the adaptor shank of the present invention with drill bit;

FIG. 5 is a partial cutaway view of the adaptor shank of FIG. 6 taken along Plane 5-5; and

FIG. 6 is a side exploded view of the adaptor shank of the present invention and drill bit.

### DETAILED DESCRIPTION OF THE INVENTION

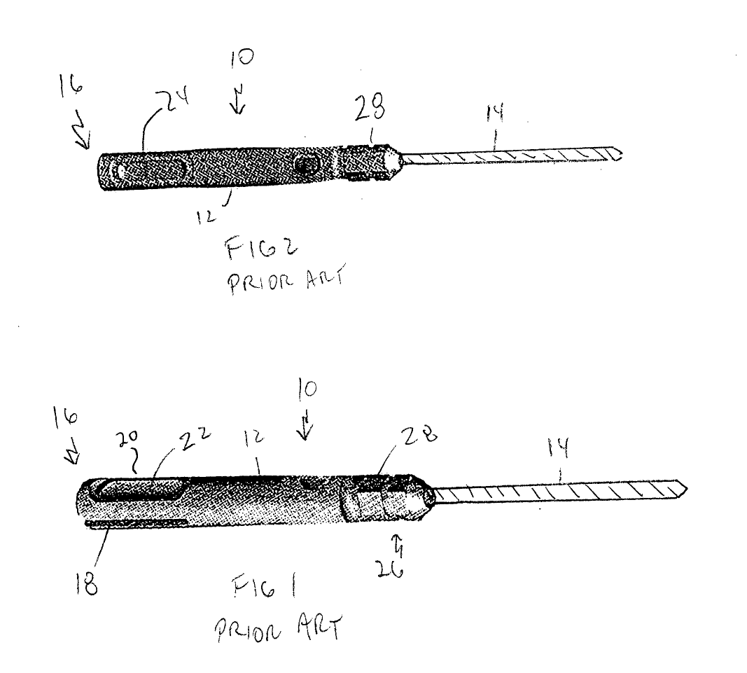

FIGS. 1 and 2 are prior art perspective views of an SDS shank and drill bit 10. The SDS shank portion 12 and the drill bit 14 are of one piece construction being milled from a single piece of steel which presents the problem which Applicant seeks to solve. In the prior art format, if the drill bit becomes worn or breaks, the one piece shank portion and the drill bit must be discarded even though the shank portion is not damaged.

The shank portion 12 has a first end 16 which is milled to provide for two opposed recessed grooves 18 and 20 which extend axially from first end 16 toward drill bit portion 14. The recessed grooves 18 and 20 are in 180 degree relationship to each other. Formed on opposing sides of first end 16 of shank portion 12 and between recessed grooves 18 and 20 are a pair of recessed arcuate indents 22 and 24 which are formed distal proximate from first end 16 of shank portion 12.

In the SDS format for pneumatic hammer/drill guns, it is this shank portion 12 which is insertably engaged within the pneumatic hammer gun or pneumatic drill gun, recessed grooves 18 and 20 serving as a guide for the insertion and recessed indents 22 and 24 engaging internal fingers of the pneumatic drill gun or pneumatic hammer gun to secure the shank portion 12 to the pneumatic drill gun or pneumatic hammer gun and thus also secure the drill bit portion 14, it being of one piece construction with the shank portion 12. The pneumatic drill gun or pneumatic hammer gun operates in a reciprocating hammer-like motion which due to its internal mechanicals and gearing, imparts a rotational force to the SDS shank and drill bit.

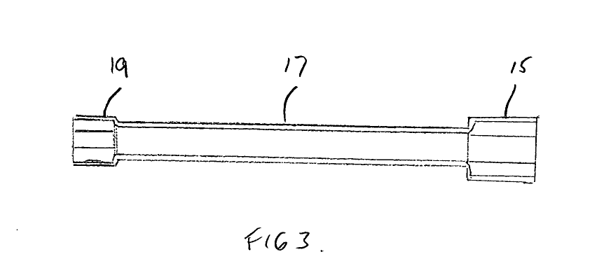

The opposing end, the drill bit end 26 of the shank portion 12 is formed with a hexagonal circumferential surface 28 which is used to engage a sleeve 17 (FIG. 3) which is slidably received over the drill bit portion 14 and end 15 and engages with the hexagonal surface 28. The sleeve 17 typically contains a driver member 19 at its opposing end illustrated in FIG. 3 as a hex drive. The driver member can consist of or comprise one of a variety of driver heads, such as a Phillips, screwdriver, Allen-head or the like.

In operation, with the SDS format shank and drill bit 10 secured to the pneumatic hammer gun or pneumatic drill gun, the operator drills the concrete or masonry hole at the location desired. The operator then inserts the sleeve over the drill bit portion 14 so that a first end of the sleeve engages the hexagonal surface 28 to lock it in position and cause it to rotate with the SDS shank and drill bit under the operation of the pneumatic hammer gun or pneumatic drill gun. This allows the opposing end of the sleeve having the drive member (Phillips head, screw head, hex head or the like) to rotate similarly and engage a concrete or masonry screw to cause the screw to be engaged within the bore or hole which was just previously drilled. Upon positioning the concrete or masonry screw, the user would remove the sleeve and driver unit and commence to bore an additional hole in the concrete or masonry in the manner described.

It is evident from the illustration of FIGS. 1 and 2, that the combination, one piece SDS format shank and drill bit 10 requires extensive and expensive machining. It therefore is an expensive item for the tradesman. Still further, when the drill bit portion 14 either wears or breaks so that it is no longer effectively usable, the tradesman or user must discard the entire piece, including the shank portion 12. This must then be replaced by a duplicate which is another expense. It would therefore be desirable if the SDS shank format and the drill bit were of a two piece combination so that the tradesman or user would only have to replace the relatively inexpensive drill bit should it become worn or broken.

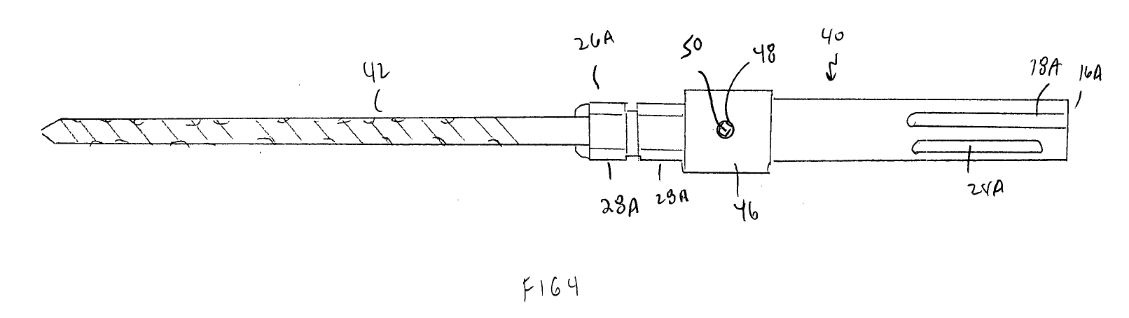

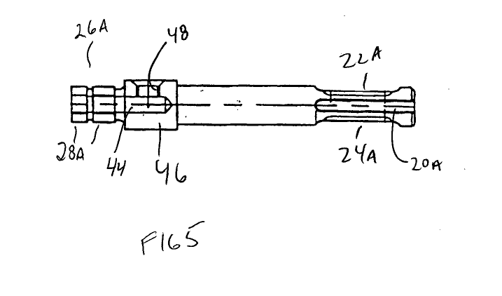

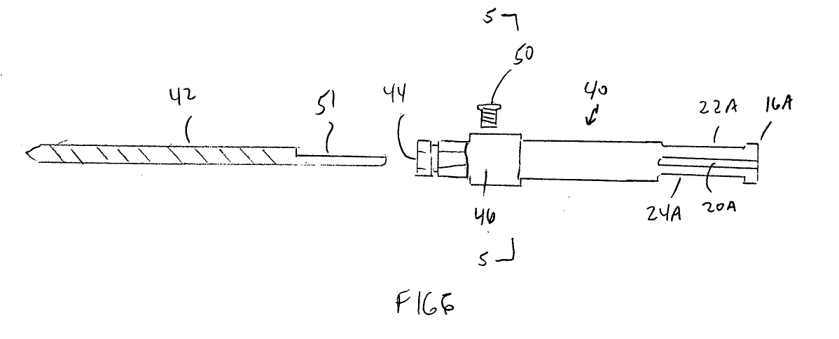

FIG. 4 is a top view of an adaptor shank 40 of the present invention, together with a drill bit 42. FIG. 5 is a cross sectional view of the adaptor shank 40 of the present invention along Plane 5-5 of FIG. 4, and FIG. 6 is a side, exploded view of the adaptor shank and drill bit of the present invention. The adaptor shank 40 of the present invention comprises an SDS format connection, which has formed therein, the opposed recessed grooves 18A and 20A and the opposed recessed indents 22A and 24A proximate first end 16A identical to the SDS shank of the prior art. The body portion first end 16A of the adaptor shank 40 is identical to the body portion of the prior art SDS shank with regards to diameter and circumference. The difference between the SDS shank and the adaptor shank lies at the drill bit engaging end 26A. Drill bit engaging end 26A is formed with hexagonal circumferential surface 28A which function in the same manner as the hexagonal circumferential surface 28 of the prior art SDS shank 12 for engagement with a sleeve and driver. However, drill bit engaging end 26A of adaptor shank 40 is formed with an axial bore 44 which extends into an expanded body portion or shoulder 46 of adaptor shank 40. The expanded body portion 46 comprises a body portion which is of greater circumference and diameter than the body portion of adaptor shank 40 which is proximate to the shank engaging end 16A.

This expanded body portion or shoulder 46 allows for a radially threaded bore 48 extending from the outer circumference of the extended body portion or shoulder 46 perpendicular to the bore 44 formed in drill bit engaging end 26A of adaptor shank 40, the two bores 44 and 48 intersecting at 90 degree angles within the adaptor shank 40. Bore 48 of extended body portion or shoulder 46 is for receipt of a threaded set screw 50. Threaded set screw 50 when secured in bore 48 and rotated accordingly, will engage a flattened end portion 51 of a drill bit 42 in order to lock drill bit 42 within bore 44 and insure its rotation with the adaptor shank 40 under the influence of the pneumatic hammer gun or pneumatic drill gun.

The engagement with the pneumatic hammer gun or pneumatic drill gun by adaptor shank 40 and drill bit 42 serves to operate in the same manner as that described with respect to the prior art. Upon completion of the drilling of a bore, a sleeve member and driver 17 can be inserted directly over the drill bit and lockingly engage the hexagonal surfaces 28A such that the pneumatic hammer gun or pneumatic drill gun can be utilized to rotate a drive member at the end of the sleeve so as to insert and secure a concrete or masonry screw into the bore just previously drilled. The process itself can be repeated as desired. The advantage of the adaptor shank 40 and drill bit 42 is that when the drill bit 42 itself becomes worn, broken or chipped, the user or tradesman need only loosen the set screw 50 in extended body portion or shoulder 46 of adaptor shank 40 so as to be able to slidably remove the broken, worn or chipped drill bit and insert a replacement drill bit rotating it accordingly until the set screw 50 can be tightened to engage the flattened end portion 51 of the inserted end. There is no requirement that the adaptor shank 40 be separated from the pneumatic hammer gun or pneumatic drill gun and the user or tradesman can quickly and efficiently accomplish this drill bit replacement without significant downtime.

While Applicant's novel contribution could be adapted to various sized pneumatic hammer guns and pneumatic drill guns, the Applicant's specific adaptation is to concrete and masonry screws and drill bits. As such, the adaptor shank as described herein would be dimensioned to receive three sixteenths concrete or masonry bits, which bits typically are utilized to install quarter inch concrete or masonry screws.

Therefore, while the present invention has been disclosed with respect to the preferred embodiments thereof, it will be recognized by those of ordinary skill in the art that various changes and modifications can be made without departing from the spirit and scope of the invention. It is therefore manifestly intended that the invention be limited only by the claims and the equivalence thereof.

I claim:

1. An adaptor shank and drill bit combination for an SDS format pneumatic hammer/drill gun for the facile drilling of bores in concrete or masonry and the installation of concrete screws therein, and the replacement of the drill bit when worn or broken, the adaptor shank and drill bit comprising:
an adaptor shank having an SDS format drill receiving end and an opposing drill bit receiving end, said drill receiving end having two opposed recessed grooves positioned in 180 degree relationship to each other on said drill receiving end, said opposed recessed grooves extending from said drill receiving end a distance towards said drill bit receiving end, said drill receiving end further having two opposing recessed indents positioned inwardly from said drill receiving end and positioned between said opposed recessed grooves, said opposed recessed grooves serving as guides for insertion of said drill receiving end of said adaptor shank into said drill gun and said recessed indents engageable with a locking mechanism on said drill gun for maintaining said adaptor shank in said drill gun;
said drill engaging end of said adaptor shank is formed with a hexagonal circumferential surface for engagement with a complimentary sleeve and driver, said drill engaging end having a longitudinal axial bore extending through said drill engaging end and terminating at an expanded shoulder portion of said adaptor shank, said expanded shoulder portion having a diameter greater than the diameter of said adaptor shank, said expanded shoulder portions having a radial threaded bore extending from an outer surface of said expanded shoulder portion and intersecting said longitudinal axial bore, said radial threaded bore for receipt of a threaded set screw;
a drill bit having a helical concrete/masonry drill end and a cylindrical adaptor shank receiving end, said cylindrical adaptor shank receiving end having a circumference equal to the circumference of said longitudinal axial bore in said drill receiving end of said adaptor shank, said cylindrical adaptor shank receiving end of said drill bit having a flattened terminus portion which seats in said expanded shoulder portion of said adaptor shank and is secured by contact with said threaded set screw in securing said drill bit in said adaptor shank.

2. The adaptor shank and drill bit combination in accordance with claim 1 wherein said adaptor shank is reusable and said drill bit is discardable when spent.

3. The adaptor shank and drill bit combination in accordance with claim 1 wherein a sleeve and driver are slidably receivable over said helical concrete masonry drill end of said drill bit and engageable with said hexagonal circumferential surface for driving a fastener into a bore.

4. An adaptor shank for an SDS format pneumatic hammer/drill gun for receipt of replaceable drill bits for the facile drilling of bores in concrete or masonry and the installation of concrete screws therein, the adaptor shank comprising:
a body member having an SDS format drill receiving end and an opposing drill bit receiving end, said drill receiving end having two opposed recessed grooves positioned in 180 degree relationship to each other on said drill receiving end, said opposed recessed grooves extending from said drill receiving end a distance towards said drill bit receiving end, said drill receiving end further having two opposing recessed indents positioned inwardly from said drill receiving end and positioned between said opposed recessed grooves, said opposed recessed grooves serving as guides for insertion of said drill receiving end of said adaptor shank into said drill gun, and said recessed indents engageable with a locking mechanism on said drill gun for maintaining said adaptor shaft in said drill gun;
said drill engaging end of said adaptor shank is being formed with a hexagonal circumferential surface for engagement with a complimentary sleeve and driver, said drill engaging end having a longitudinal axial bore extending through said drill engaging end and terminating at an expanded shoulder portion of said adaptor shank, said expanded shoulder portion having a diameter greater than the diameter of said adaptor shank, said expanded shoulder portion having a radial threaded bore extending from an outer surface of said expanded shoulder portion and intersecting said longitudinal axial bore, said radial threaded bore for receipt of a threaded set screw.

5. The adaptor shank in accordance with claim 4 wherein said longitudinal axial bore has a diameter complimentary for receipt of a drill bit, said drill bit having a helical concrete/masonry drill end, and a cylindrical adaptor shank receiving end having a flattened terminus portion which seats in said longitudinal axial bore in said expanded shoulder portion of said adaptor shank and is frictionally engaged and secured by said threaded set screw.

6. The adaptor shank in accordance with claim 5 wherein said adaptor shank is reusable and said drill bit is discardable when spent.

7. The adaptor shank in accordance with claim 5 wherein said sleeve and driver are slidably receivable over said helical concrete masonry drill end of said drill bit and engageable with said hexagonal circumferential surface of said adaptor shank.
